(19) United States
(12) Patent Application Publication
(10) Pub. No.: US 2010/0111145 A1
(43) Pub. Date: May 6, 2010

(54) BASEBAND UNIT HAVING BIT REPETITIVE ENCODED/DECODING

(75) Inventors: JASON A. TRACHEWSKY, MENLO PARK, CA (US); CHRISTOPHER J. HANSEN, SUNNYVALE, CA (US); ANDREW J. BLANKSBY, NEPTUNE, NJ (US); MURAT MESE, RANCHO PALOS VERDES, CA (US); BA-ZHONG SHEN, IRVINE, CA (US)

Correspondence Address: GARLICK HARRISON & MARKISON, P.O. BOX 160727, AUSTIN, TX, 78716-0727, US

(73) Assignee: BROADCOM CORPORATION, IRVINE, CA (US)

(21) Appl. No.: 12/605,088

(22) Filed: Oct. 23, 2009

Related U.S. Application Data
(60) Provisional application No. 61/111,685, filed on Nov. 5, 2008.

(51) Int. Cl. H04B 1/38; H04L 27/00

(52) U.S. Cl. 375/220; 375/295

(57) ABSTRACT

A baseband unit includes an input/output interface and a processing module. The input/output interface module receives a data word of outbound data and outputs a plurality of outbound symbols. The processing module converts the data word into a bit repetitive data word; encodes the bit repetitive data word to produce an encoded data block; and converts the encoded data block into the plurality of outbound symbols.

This patent application is claiming priority under 35 USC §119 to a provisionally filed patent application entitled 60 GHz SINGLE CARRIER MODULATION, having a provisional filing date of Nov. 5, 2008, and a provisional Ser. No. 61/111,685.

### STATEMENT REGARDING FEDERALLY SPONSORED RESEARCH OR DEVELOPMENT

NOT APPLICABLE

### INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to wireless communication systems and more particularly to wireless communication devices that operate in such systems.

2. Description of Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), Enhanced Data rates for GSM Evolution (EDGE), General Packet Radio Service (GPRS), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF modem, etc.). As is known, the receiver is coupled to an antenna and includes a low noise amplifier, one or more intermediate frequency stages, a filtering stage, and a data recovery stage. The low noise amplifier receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

As is also known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

While transmitters generally include a data modulation stage, one or more IF stages, and a power amplifier, the particular implementation of these elements is dependent upon the data modulation scheme of the standard being supported by the transceiver. For example, if the baseband modulation scheme is Gaussian Minimum Shift Keying (GMSK), the data modulation stage functions to convert digital words into quadrature modulation symbols, which have a constant amplitude and varying phases. The IF stage includes a phase locked loop (PLL) that generates an oscillation at a desired RF frequency, which is modulated based on the varying phasesproduced by the data modulation stage. The phase modulated RF signal is then amplified by the power amplifier in accordance with a transmit power level setting to produce a phase modulated RF signal.

As another example, if the data modulation scheme is 8-PSK (phase shift keying), the data modulation stage functions to convert digital words into symbols having varying amplitudes and varying phases. The IF stage includes a phase locked loop (PLL) that generates an oscillation at a desired RF frequency, which is modulated based on the varying phasesproduced by the data modulation stage. The phase modulated RF signal is then amplified by the power amplifier in accordance with the varying amplitudes to produce a phase and amplitude modulated RF signal.

As the desire for wireless communication devices to support multiple standards continues, recent trends include the desire to integrate more functions on to a single chip. For instance, as standards develop for the 60 GHz frequency band (e.g., 57 GHz to 66 GHz), it is desired to have communication devices be able to function in the 60 GHz frequency band as well as other standards (e.g., IEEE 802.11, GSM, CDMA, etc.) in different frequency bands (e.g., 900 MHz, 1800 MHz, 1900 MHz, 2100 MHz, 2.4 GHz, 5 GHz, 29 GHz, etc.).

When operating in the 60 GHz frequency band, it is desirable to operate at very high speeds (e.g., greater than 1 Giga-bit-per-second). However, there are times when a device will not be able at such data rates and have to use a “fall-back” data rate (e.g., 375 Mbps). In these instances, repeating data bits is useful to improve the reliability of data transmissions, but can introduce spectral lines or tones into the transmitting and, hence, the received signal. Such spectral lines or tones reduce the reception quality thereby making such solutions less than optimal.

Therefore, a need exists for a wireless communication device that at least partially overcomes one or more of the wireless communication device issues discussed above.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a millimeter wave network in accordance with an embodiment of the present invention;

FIG. 2 is a schematic block diagram of an embodiment of a baseband processing module in accordance with an embodiment of the present invention;

FIG. 3 is a schematic block diagram of another embodiment of a baseband processing module in accordance with an embodiment of the present invention;

FIG. 4 is a diagram of an example of a data block in accordance with an embodiment of the present invention;

FIG. 5 is a diagram of an example of bit repetition processing in accordance with an embodiment of the present invention;

FIG. 6 is a diagram of another example of bit repetition processing in accordance with an embodiment of the present invention; and

FIG. 7 is a logic diagram of an embodiment of a method for bit repetition processing in accordance with an embodiment of the present invention.

### DETAILED DESCRIPTION OF THE INVENTION

FIG. 1 is a schematic block diagram of an embodiment of a millimeter wave network that includes a plurality of wireless communication devices 10-12. The wireless communication devices 10-12 may be a personal computer, laptop computer, personal entertainment device, cellular telephone, personal digital assistant, a game console, a game controller, and/or any other type of device that communicates real-time and/or non-real-time signals via a wireless connection. Each of the wireless communication devices 10-12 includes a millimeter wave (MMW) transceiver 16 and a baseband unit 14. The MMW transceiver 16 includes at least one receiver section and at least one transmitter section that allow the device to support one or more standards (e.g., GSM, IEEE 802.11, WCDMA, 60 GHz, etc.) in one or more frequency bands.

The baseband unit 14 includes a processing module 48 and one or more input/output (I/O) interface modules (e.g., one or more of integrated circuit (IC) pins, general purpose input/output (GPIO), buffers, drivers, wires, IC traces, etc.). The processing module may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 1-7.

In operation, the receiver section of the MMW transceiver is operable to amplify an inbound MMW signal (e.g., carrier frequency in the rage of 3 GHz to 300 GHz) to produce an amplified inbound MMW signal. The receiver section may then mix in-phase (I) and quadrature (Q) components of the amplified inbound MMW signal with in-phase and quadrature components of a local oscillation to produce a mixed I signal and a mixed Q signal. The mixed I and Q signals are combined to produce an inbound symbol stream. In this embodiment, the inbound symbol may include phase information (e.g., +/−Δθ[phase shift] and/or θ(t) [phase modulation]) and/or frequency information (e.g., +/−Δf [frequency shift] and/or f(t) [frequency modulation]). In another embodiment and/or in furtherance of the preceding embodiment, the inbound RF signal includes amplitude information (e.g., +/−ΔA [amplitude shift] and/or A(t) [amplitude modulation]). To recover the amplitude information as part of the inbound symbol stream, the receiver section includes an amplitude detector such as an envelope detector, a low pass filter, etc. The baseband unit 14 converts the inbound symbol stream into inbound data as will be discussed in greater detail with reference to FIGS. 2-7.

The baseband unit 14 is further operable to convert outbound data (e.g., voice, audio, video, text, graphics, etc.) into an outbound symbol stream as will be discussed in greater detail with reference to FIGS. 2-7. The transmitter section of the MMW transceiver converts the outbound symbol stream into an outbound MMW signal. This may be done in a variety of ways. For example, the transmitter section may mix the outbound symbol stream with a local oscillation to produce an up-converted signal. One or more power amplifiers and/or power amplifier drivers amplifies the up-converted signal, which may be MMW bandpass filtered, to produce the outbound MMW signal. In another embodiment, the transmitter section includes an oscillator that produces an oscillation. The outbound symbol stream provides phase information (e.g., +/−Δθ[phase shift] and/or θ(t) [phase modulation]) that adjusts the phase of the oscillation to produce a phase adjusted MMW signal, which is transmitted as the outbound MMW signal. In another embodiment, the outbound symbol stream includes amplitude information (e.g., A(t) [amplitude modulation]), which is used to adjust the amplitude of the phase adjusted MMW signal to produce the outbound MMW signal.

In yet another embodiment, the transmitter section includes an oscillator that produces an oscillation. The outbound symbol provides frequency information (e.g., +/−Δf [frequency shift] and/or f(t) [frequency modulation]) that adjusts the frequency of the oscillation to produce a frequency adjusted MMW signal, which is transmitted as the outbound MMW signal. In another embodiment, the outbound symbol stream includes amplitude information, which is used to adjust the amplitude of the frequency adjusted MMW signal to produce the outbound MMW signal. In a further embodiment, the transmitter section includes an oscillator that produces an oscillation. The outbound symbol provides amplitude information (e.g., +/−ΔA [amplitude shift] and/or A(t) [amplitude modulation) that adjusts the amplitude of the oscillation to produce the outbound MMW signal.

The conveyance of a MMW signal from one wireless communication device to the other is done in accordance with a particular standardized protocol, which describes a frame format. In addition, a communication typically includes a detection period and a clear channel period (CE). In the example of the FIG. 1, a frame includes one or more header sections and one or more data fields (which includes one or more guard intervals and one or more data blocks). Note that a frame may be transmitted in one or more data bursts.

The particular protocol generally dictates the format of the header. For example, the header may be contained in one of the single carrier modulation (SCM) blocks that includes 448 symbols. It may be formatted in a shortened r=½ code (LDPC (448,112)) with factor-of-2 outer repetition code and include 56 bits of information. In addition, the header may be scrambled from bit 7 forward and/or have the scrambler restarted at the start of the data.

The header section may include the following fields:

| | Number | Start | |
|---|---|---|---|
| Field Name | of bits | Bit | Description |
| Scrambler | 7 | 0 | bits X1-X7 of the initial scrambler state. |
| Initialization | | | |
| MCS | 8 | 7 | Index into the Modulation and Coding |
| | | | Scheme table |
| Additional | 1 | 15 | A value of 1 Indicates that this PDDU is |
| PPDU | | | immediately followed by another PPDU |
| | | | with no IFS or preamble on the subsequent |
| | | | PPDU. A value of 0 indicates that no |
| | | | additional PPDU follows this PPDU. |
| Length | 18 | 16 | Number of data octets in the PSDU. |
| | | | Range 0-262143 |
| Reserved | 6 | 34 | Set to 0, ignored by receiver |
| HCS | 16 | 40 | Header check sequence |

The scrambler initialization includes 7 bits that set the initial state of the scrambler shift register. In an embodiment, the bits should be as random as possible on every transmission of a burst. Note that both the header and the data field (e.g., PSDU) are scrambled by the same sequence and that the scrambler may be reset again to the scrambler seed at the start of the PSDU and also at the start of the header repetition if the MCS is 0.

FIG. 2 is a schematic block diagram of an embodiment of a baseband unit 14 that includes a processing module 48 and one or more input/output modules (I/O). The processing module 48 supports a transmit baseband section and a receive baseband section. The transmit baseband section includes a scramble module 20, a bit repetition process module 22, an encoder 24 (e.g., low density parity check (LDPC)), a binary and/or quadrature phase shift keying (B/QPSK) module 26, a phase rotation module 28 (e.g., π/2), a filter 30 (e.g., low pass and/or bandpass filter), and a modulator 32 (e.g., base band to low intermediate frequency (IF)). The receive baseband section includes a demodulator 34 (e.g., low IF to baseband), a filter 36 (e.g., low pass and/or bandpass), a phase rotation decoding module 38 (e.g., π/2), B/QPSK demapping module 40, a decoding module 42 (e.g., LDPC), a bit repetition decoding module 44, and a de-scramble module 46.

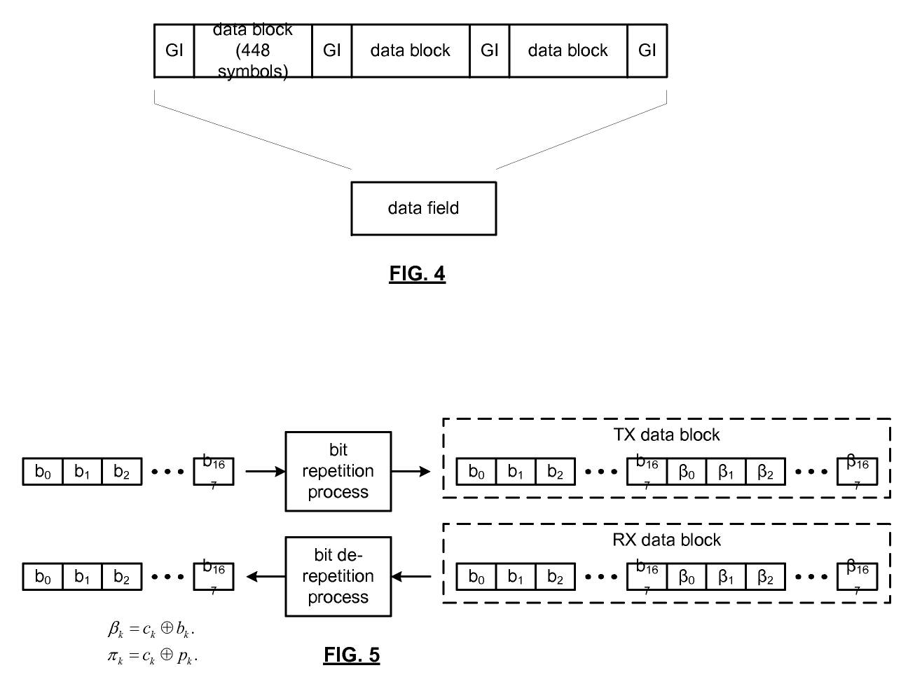

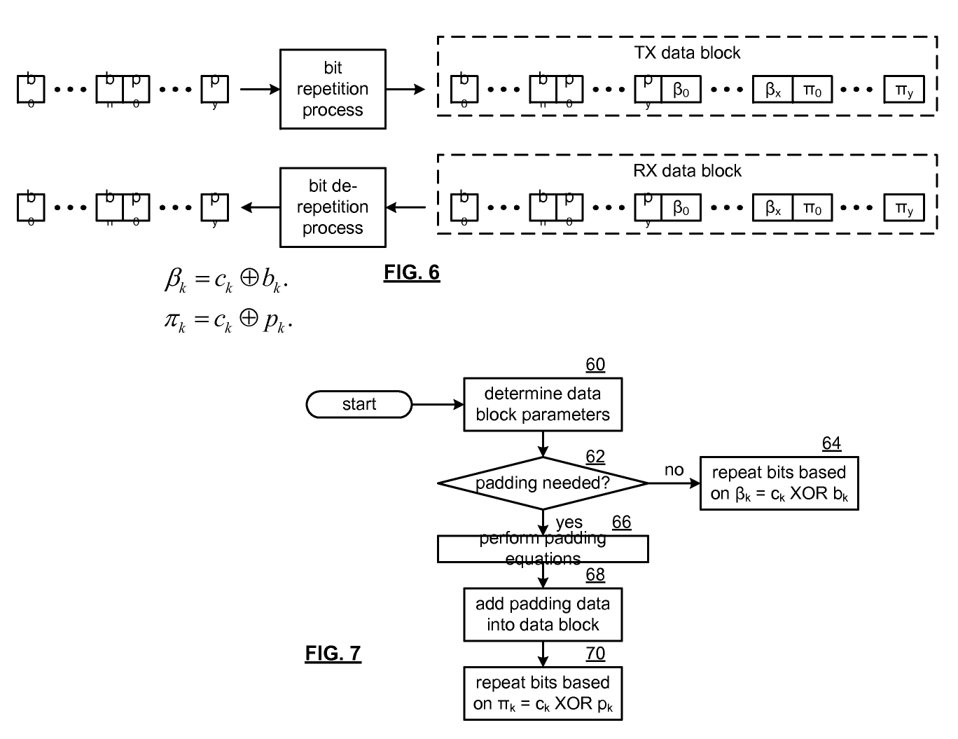

For outbound data, the scramble module scrambles an outbound data word (e.g., 168 bits) to produce a scramble data word. The bit repetition module repeats the bits of the scrambled data word, processes the repeated bits to produce a random sequence of repeated bits, and appends the random sequence of repeated bits to the scrambled data word to produce a repeated data word (e.g., 336 bits). In this regard, the bit repetition module is adding redundancy to the data to improve data transmission integrity and substantially avoids injection of spectral lines or tones via the processing to produce the random sequence. For example, the repeated bits may be exclusively ORed with a pseudo random sequence at a known initialization point to produce the random sequence. Examples of this are provided in FIGS. 5 and 6.

The LDPC encoding module encodes the repeated data word to produce an LDPC encoded data word (e.g., 672 bits). The B/QPSK mapping module maps bits of the encoded data word to a binary constellation (e.g., +1 or −1) or a quadrature constellation (e.g., +1, −1, +i, or −i). The π/2 rotation module rotates each mapped symbol outputted by the B/QPSK mapping module by π/2 to produce rotated symbols. The filter (e.g., LPF or BPF) filters the rotated symbols to produce filtered symbols. The modulator modulates the filtered symbols to convert the outbound symbol stream from a baseband signal to a low intermediate frequency signal. Alternatively, the modulator may be omitted, and the baseband outbound symbol stream may be provided directly to the transmitter section of the MMW transceiver.

The receiver side of the processing module essentially performs the inverse of the corresponding components of the transmitter side. In particular, the demodulator demodulates a low inbound IF symbol stream to produce a baseband inbound symbol stream. The filter filters the inbound symbol stream, which is decoded via the π/2 rotation decoding module to produce inbound mapped symbols. The B/QPSK demapping module demaps the inbound mapped symbols to recover the repeated data word. The LDPC decoding module decodes the repeated data word to recover the repeated data word.

The bit repetition decoding module, utilizing the known random sequence used by the bit repetition encoding module, decodes the repeated data word to recover the scrambled data word. The de-scramble module descrambles the scrambled data word to produce the inbound data.

FIG. 3 is a schematic block diagram of another embodiment of a baseband unit 14 that includes the processing module 48 and one or more IO interface modules. The processing module 48 supports a transmit baseband section and a receive baseband section. The transmit baseband section includes a scramble module 20, a bit repetition process module 22, an encoder 24, and a minimum shift keying (MSK) or Gaussian (GMSK) modulator 50. The receive baseband section includes a G/MSK demodulator 52, a decoding module 42, a bit repetition decoding module 44, and a de-scramble module 46.

For outbound data, the scramble module scrambles an outbound data word (e.g., 168 bits) to produce a scramble data word. The bit repetition module repeats the bits of the scrambled data word, processes the repeated bits to produce a random sequence of repeated bits, and appends the random sequence of repeated bits to the scrambled data word to produce a repeated data word (e.g., 336 bits). In this regard, the bit repetition module is adding redundancy to the data to improve data transmission integrity and substantially avoids injection of spectral lines or tones via the processing to produce the random sequence. For example, the repeated bits may be exclusively ORed with a pseudo random sequence at a known initialization point to produce the random sequence. Examples of this are provided in FIGS. 5 and 6.

The LDPC encoding module encodes the repeated data word to produce an LDPC encoded data word (e.g., 672 bits). The MSK modulator modulates the output of the summing module to produce the outbound symbol stream.

The receiver side of the processing module essentially performs the inverse of the corresponding components of the transmitter side. In particular, the G/MSK demodulator demodulates an inbound symbol stream. The LDPC decoding module decodes the output of the MSK demodulator to recover the repeated data word.

The bit repetition decoding module, utilizing the known random sequence used by the bit repetition encoding module, decodes the repeated data word to recover the scrambled data word. The de-scramble module descrambles the scrambled data word to produce the inbound data. In this embodiment, the GMSK modulation, which is a constant envelop modulation, approximates the π/2 rotation and B/QPSK functions.

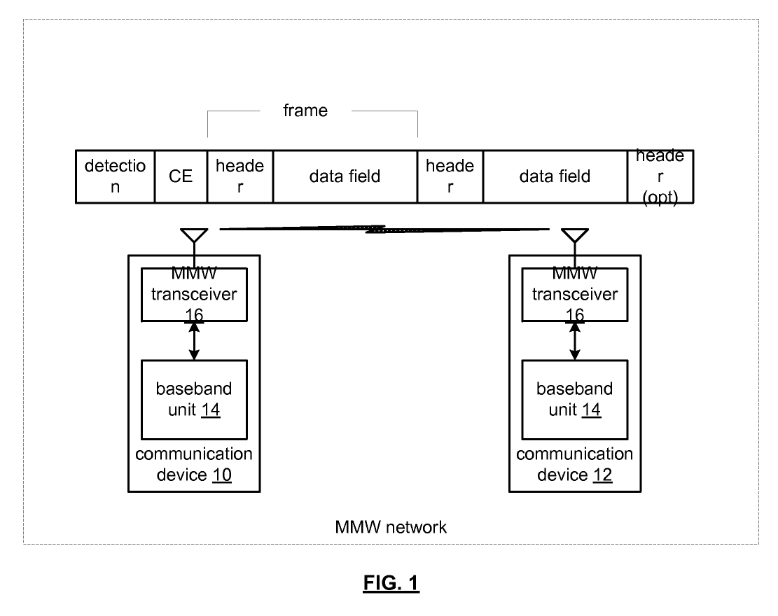

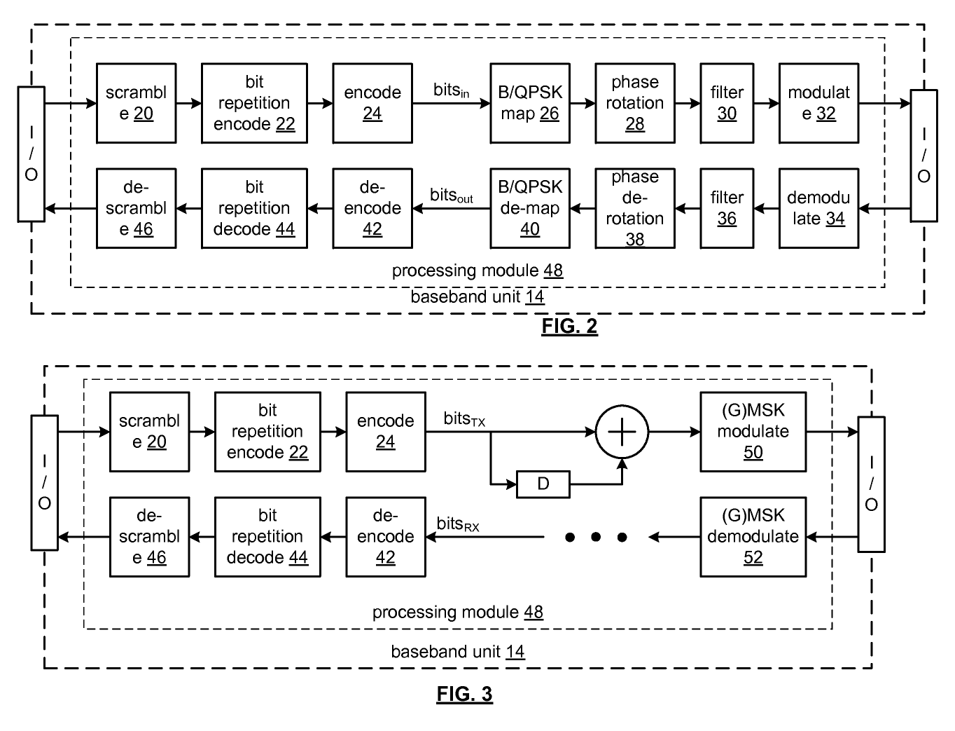

FIG. 4 is a diagram of an example of a data field of a frame that includes one or more guard intervals (GI) and one or more data blocks. In this example, each GI may include 64 symbols and each data block may include 448 symbols. In this instance, two 672-bit LDPC codewords fit into 3 blocks of data for π/2-BPSK such that shortening is only performed at end of a frame using rules similar to the OFDM spec. Alternatively, four 672-bit LDPC codewords fit into 3 blocks of data for π/2-QPSK. In either instance, the guard interval may be a fixed L=64 Golay sequence instead of a cyclic prefix, though blocks may still have a cyclic property if the GI of the next symbol is included.

FIG. 5 is a diagram of an example of bit repetition processing of a data word that includes a number of bits (e.g., 168 bits outputted of a scrambler in the baseband receive path) as performed by the bit repetition module 22. The bit repetition process repeats the bits (bₖ) and exclusive ORs them with a pseudo random sequence (cₖ) to produce the repeated bits (βₖ). The bit repetition module appends the repeated bits on the original bits to produce the repeated data word of 336 bits.

On the receive side, the bit repetition decoding module 44 receives a repeated data word, exclusive ORs it with the pseudo random sequence (ck) to recover the repeated bits. From the original bits bₖ and the repeated bits, the bit repetition decoding module recovers the scrambled data word.

FIG. 6 is a diagram of another example of bit repetition processing where the data word includes less than the number of bits (e.g., 168 bits or another number), which may occur at the end of a frame. In this instance, the bit repetition module determines that the received data word includes less than 168 bits (or some other size). The bit repetition module adds padding data (pₖ) to the bits of the data word (bₖ) to provide a word of 168 bits. The bit repetition module functions as previously described to produce the repeated data word that includes repeated bits of the desired data (βₖ) and repeated bits of the padded data (πk).

On the receive side, the bit repetition module recovers the original bits and the padding bits as previously discussed. The bit repetition module then determines the padding bits and removes them such the only the bits of interest are left.

FIG. 7 is a logic diagram of an embodiment of a method for bit repetition processing. The method begins at step 60 where the processing module determines parameters of the data block (e.g., maximum size, number of bits, etc.). The method continues at step 62 where the processing module determines whether padding is needed (e.g., is the current data block is the last of a frame and includes less than a maximum of bits). If not, the method continues at step 64 where the processing module repeats the bits as previously discussed with reference to FIG. 5.

When padding is needed, the method continues at step 66 where the processing module performs one or more padding equations. Such padding equations include

$${N}_{CW} = ⌈ \frac{Length \cdot 8}{{L}_{CW} \cdot R} ⌉$$

$${N}_{DATA\_PAD} = {N}_{CW} \cdot {L}_{CW} \cdot R - Length \cdot 8$$

$${N}_{BLKS} = ⌈ \frac{{N}_{CW} \cdot {L}_{CW}}{{N}_{CBPB}} ⌉$$

$${N}_{BLK\_PAD} = {N}_{BLKS} \cdot {N}_{CBPB} - {N}_{CW} \cdot {L}_{CW}$$

where:
R=code rate, Length=number of input data bytes (or total replicated data bytes for MCS 0)
L_{CW}=length of code word (672 bits), N_{CW}=# codewords
N_{DBPB}=# data (information) bits per block, N_{CBPB}=# coded bits per block=N_{DBPB}/R
N_{DATA}_{_{—}}_{PAD}=# data pad bits
N_{BLKS}=# blocks of SC symbols
N_{BLK}_{_{—}}_{PAD}=# of block pad bits.

The method then continues at steps 68 and 70 where the processing module adds the padding bits and repeats the bits are previously described with reference to FIG. 6.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A baseband unit comprises:
an input/output interface module operably coupled to:
receive data word of outbound data; and
output a plurality of outbound symbols; and
a processing module operably coupled to:
convert the data word into a bit repetitive data word;
encode the bit repetitive data word to produce an encoded data block; and
converting the encoded data block into the plurality of outbound symbols.

2. The baseband unit of claim 1, wherein the processing module converts the data word into a bit repetitive data word by:
scrambling the data word to produce a scrambled data word;
generating repeat bits from the scrambled data word; and
appending the repeat bits to the scrambled data word to produce the bit repetitive data word.

3. The baseband unit of claim 2, wherein the processing module generates the repeat bits by:
exclusive ORing bits of the scrambled data word with bits of a pseudo random sequence to produce the repeated bits.

4. The baseband unit of claim 1, wherein the processing module converts the data word into a bit repetitive data word by:
scrambling the data word to produce a scrambled data word;
determining whether the scrambled data word requires padding;
when the scrambled data word requires padding, padding the scrambled data word in accordance with one or more padding equations to produce a padded scrambled data word;
generating repeat bits from the padded scrambled data word; and
appending the repeat bits to the padded scrambled data word to produce the bit repetitive data word.

5. The baseband unit of claim 1, wherein the processing module converts the data word into a bit repetitive data word by:
generating repeat bits from the data word; and
scrambling the repeat bits and the data word to produce to produce the bit repetitive data word.

6. The baseband unit of claim 1, wherein the processing module converts the encoded data block into the plurality of outbound symbols by:
mapping bits of the encoded data block to a binary constellation or a quadrature constellation to produce a plurality of mapped symbols;
phase rotating each of the plurality of mapped symbols to produce a plurality of rotated symbols; and
filtering the plurality of rotated symbols to produce the plurality of outbound symbols.

7. The baseband unit of claim 1, wherein the processing module converts the encoded data block into the plurality of outbound symbols by:
mapping bits of the encoded data block to a binary constellation or a quadrature constellation to produce a plurality of mapped symbols;
phase rotating each of the plurality of mapped symbols to produce a plurality of rotated symbols;
filtering the plurality of rotated symbols to produce the plurality of filtered symbols; and
modulating the plurality of filtered symbols to produce the plurality of outbound symbols.

8. The baseband unit of claim 1, wherein the processing module converts the encoded data block into the plurality of outbound symbols by:
minimum shift keying bits of the encoded data block to produce the plurality of outbound symbols.

9. A baseband unit comprises:
a processing module operably coupled to convert outbound data into a frame, wherein the frame includes a header field and a data field, wherein the data field includes a plurality of guard intervals and a plurality of data blocks, wherein a data block of the plurality of data blocks includes repeat bits and data bits; and
an output interface module operably coupled to output the frame.

10. The baseband unit of claim 9, wherein the processing module further functions to:
scramble a data word of the outbound data to produce a scrambled data word;
generating the repeat bits from the scrambled data word; and
appending the repeat bits to the scrambled data word to produce the data block, wherein the data bits correspond to the scrambled data word.

11. The baseband unit of claim 10, wherein the processing module generates the repeat bits by:
exclusive ORing bits of the scrambled data word with bits of a pseudo random sequence to produce the repeated bits.

12. The baseband unit of claim 9, wherein the processing module further functions to:
scramble a data word of the outbound data to produce a scrambled data word;
determine whether the scrambled data word requires padding;
when the scrambled data word requires padding, pad the scrambled data word in accordance with one or more padding equations to produce a padded scrambled data word;
generate the repeat bits from the padded scrambled data word; and
append the repeat bits to the padded scrambled data word to produce the data block, wherein the data bits correspond to the padded scrambled data word.

13. The baseband unit of claim 9, wherein the processing module further functions to:
generate the repeat bits from a data word of the outbound data; and
scramble the repeat bits and the data word to produce to produce the data block.

14. A baseband unit comprises:
an input/output interface module operably coupled to:
receive a plurality of inbound symbols; and
output a data word of inbound data; and
a processing module operably coupled to:
converting the plurality of inbound symbols into an encoded bit repetitive data word;
decode the encoded bit repetitive data word to produce a bit repetitive data word; and
convert the bit repetitive data word into the data word.

15. The baseband unit of claim 14, wherein the processing module converts the bit repetitive data word into the data word by:
bit repetition decoding the bit repetitive data word to produce a scrambled data word; and
de-scrambling the scrambled data word to produce the data word.

16. The baseband unit of claim 15, wherein the processing module bit repetition decodes the bit repetitive data word by:
exclusive ORing bits of the bit repetitive data word with bits of a pseudo random sequence to produce the scrambled data word.

17. The baseband unit of claim 15, wherein the processing module bit repetition decodes the bit repetitive data word by:
exclusive ORing bits of the bit repetitive data word with bits of a pseudo random sequence to produce a padded and scrambled data word; and
de-padding the padded and scrambled data word to produce the scrambled data word.

18. The baseband unit of claim 14, wherein the processing module converts the plurality of inbound symbols into an encoded bit repetitive data word by:
filtering the plurality of inbound symbols to produce a plurality of filtered inbound symbols;
de-phase rotating each of the plurality of filtered inbound symbols to produce a plurality of mapped symbols; and
de-mapping, in accordance with a binary constellation or a quadrature constellation, the plurality of mapped symbols to produce the encoded bit repetitive data word.

19. The baseband unit of claim 14, wherein the processing module converts the plurality of inbound symbols into an encoded bit repetitive data word by:
demodulating the plurality of inbound symbols to produce a plurality of demodulated inbound symbols;
filtering the plurality of demodulated inbound symbols to produce a plurality of filtered inbound symbols;
de-phase rotating each of the plurality of filtered inbound symbols to produce a plurality of mapped symbols; and
de-mapping, in accordance with a binary constellation or a quadrature constellation, the plurality of mapped symbols to produce the encoded bit repetitive data word.

20. The baseband unit of claim 14, wherein the processing module converts the plurality of inbound symbols into an encoded bit repetitive data word by:
minimum shift de-keying the plurality of inbound symbols to produce bits of the encoded bit repetitive data word.

21. A baseband unit comprises:
a processing module operably coupled to convert a frame into inbound data, wherein the frame includes a header field and a data field, wherein the data field includes a plurality of guard intervals and a plurality of data blocks, wherein a data block of the plurality of data blocks includes repeat bits and data bits of the inbound data; and
an output interface module operably coupled to output the data bits of the inbound data.

22. The baseband unit of claim 21, wherein the processing module further functions to:
bit repetition decoding a bit repetitive data word of the data block to produce a scrambled data word; and
de-scrambling the scrambled data word to produce the data word.

23. The baseband unit of claim 22, wherein the processing module bit repetition decodes the bit repetitive data word by:
exclusive ORing bits of the bit repetitive data word with bits of a pseudo random sequence to produce the scrambled data word.

24. The baseband unit of claim 22, wherein the processing module bit repetition decodes the bit repetitive data word by:
exclusive ORing bits of the bit repetitive data word with bits of a pseudo random sequence to produce a padded and scrambled data word; and
de-padding the padded and scrambled data word to produce the scrambled data word.
